(19) United States
(12) Patent Application Publication
(10) Pub. No.: US 2011/0212372 A1
(43) Pub. Date: Sep. 1, 2011

(54) Motion fuel cell

(76) Inventor: Richard McElroy, Kamloops (CA)

(21) Appl. No.: 13/064,950

(22) Filed: Apr. 28, 2011

Related U.S. Application Data
(63) Continuation-in-part of application No. 11/892,442, filed on Aug. 23, 2007.

(51) Int. Cl. H01M 8/04; H01M 8/06

(52) U.S. Cl. 429/414; 429/434

(57) ABSTRACT

A fuel cell system (with reference to a single cell arrangement) comprising means to provide for the reciprocating, oscillating and or vibrational motion-movement of an assembly comprised of an electrolyte sandwiched between an anode-electrode and a cathode-electrode; said motion-movement serving to accelerate electrochemical activity within the fuel cell by providing for accelerated reactant exposure to respective electrodes; including instant water removal at the cathode-electrode surface; and boosted cooling to said anode-electrode; while offering accelerated (anti electroosmotic) moisturizing to the specific benefit of the anode side of a polymer electrolyte.

The Patent application in hand is a “Continuation in part” application, claiming priority of Non-Provisional application Ser. No. 11/892,442; Filed: Aug. 23, 2007; Titled: “Motion Fuel Cell”; Art Unit 1728; Examiner: Maples, John S.

### BACKGROUND OF THE INVENTION

1. Technical Field

The present invention relates to electrochemical fuel cells in general; of which, conventionally, the components of a single unit cell would include: an electrolyte sandwiched between an anode-electrode and a cathode-electrode and the interconnect material. The invention is particularly directed to accelerated electrochemical activity, improvements in reactant distribution, improved water management and removal at cathode, controlled anodic cooling; and with particular reference to Polymer Electrolyte Membrane (PEM) fuel cells: increased humidification to the anode side of the PEM; and in any fuel cell, enhancing potential advantages and overcoming certain limitations that will benefit transportation and or stationary applications.

2. Background Art

There are well known various constructions and types of fuel cells; and they are primarily classified by the type of electrolyte employed, which determines the fuel required, the temperature range of operation, if precious-metal catalysts are required; and in turn what applications they are most suited to. These various types of fuel cells are continually being further developed; however, with certain advantages and limitations to any particular application.

Although aspects of the present invention may apply and offer advantage to various and diverse types of fuel cells, the conventional technology of a single PEM fuel cell and its electrochemical function is described in following detail:

The Polymer Electrolyte Membrane (such as are available, for example, under the trademark Nafion) is interposed between an anode-electrode and a cathode-electrode, and receives (at the anode-electrode surface) a gaseous fuel (H2); and (at the cathode-electrode surface) an (02) oxygen-containing gas, i.e., oxygen gas or air. The reactants are distributed as evenly as possible over the respective electrode plates. The electrode plate surfaces facing the polymer electrolyte membrane (PEM) are provided with a layer of a precious-metal catalyst (usually platinum). An electrochemical reaction takes place at and between the said respective electrodes and the electrolyte. That is, hydrogen supplied to the anode-electrode is converted into hydrogen ions (H+ cations) at the said electrode catalyst by the loss of electrons. The hydrogen ions (protons) are drawn to the cathode-electrode through the polymer electrolyte (which must be humidified). The electrons generated (released from the ions) during this oxidation process are drawn through an external circuit, thus producing direct current and usable electrical energy.

As the electrons return, and are gained, at the reduction side of the fuel cell (i.e., the cathode-electrode) a complete circuit is resulted. Oxygen gas or air is supplied to the cathode-electrode; where, the hydrogen ions (i.e., protons, having come through the said electrolyte membrane), combine with the electrons (i.e., having returned from the external circuit) and with the said supplied oxygen to react with each other to produce water at the cathodic-electrode surface; completing the basic function of the fuel cell, i.e., the generation of electric power.

With respect to PEM fuel cell technology, both advantages and limitations remain over other fuel cell types. However, according to the Department of Energy (DOE) the advantages over other fuel cell systems for producing economical and technologically viable electrical current load required by a light duty automobile that would adequately approach conventional performance and cost, at this stage of development, remains a PEM fuel cell; largely, because of fast start capability operating at lower temperatures. Example, according to the DOE, Solid Oxide Fuel Cells (SOFC) are capable of generating more power, but require a substantial warm up period and operate at extremely high temperatures (1000 degrees C.); therefore, such are seen as auxiliary power units on heavy duty vehicles where systems may run for extended periods without frequent start and stop cycles. The disadvantages of the high operating temperatures (i.e., slow start-up, high heat shielding materials required); however, offer a significant advantage over PEM fuel cells, in that the high temperatures eliminate the need for precious metal catalysts, reducing a significant cost, which present low temperature PEM systems must accept. Another advantage over the PEM fuel cell is that the SOFC electrolyte is a solid, hard nonporous ceramic material, which allow for greater pressure differences between the anode and cathode chambers; as well, allowing for greater diversity in cell design. Direct Methanol Fuel Cells (DMFCs), according to the DOE, seem to be well suited for portable power applications where the power requirements are low and the cost targets are not as stringent as for transportation applications. However, DMFC's offer advantage over PEM systems in that methanol is a higher density fuel than reformed hydrogen, allowing for greater onboard storage of consumable energy and therefore greater range in transportation applications. As well methanol is a liquid fuel, offering the said transportation application the advantage of present dispensing infrastructure, i.e., gas pumps, tank storage and present delivery systems. DMFC's are fuelled by pure methanol, entrained with water-steam, supplied at the anode.

As referenced above, the low energy density of pure hydrogen, as a fuel, presents a problem for a PEM fuel cell fed by pure hydrogen, when considering on-board fuel supply and range in transportation applications. The reforming of fuel, on-board, i.e., extracting pure hydrogen from hydrogen rich fuels for use in the fuel cell, is not a possible option at present because reformers require high heat to function; and conventional low heat PEM's do not provide the heat by-product needed. This leaves the option of increasing the heat out-put of a PEM fuel cell to be able to reform its own pure hydrogen supply from other fuels delivered on-board; potentially, liquid hydrocarbons could be reformed; in that catalysts more resistant to carbon monoxide (CO) contamination (i.e., platinum/ruthenium catalysts) are being explored. Another, perhaps favoured option being advanced is to compress pure hydrogen at great density (as much as 10,000 psi) in, on-board, high pressure composite fuel tanks. Such is presently being developed, tested and showing some promise; however, at certain cost. 008. Further, with regard to PEM fuel cells, according to the DOE, the cost, performance and durability of fuel cell power systems must be improved to be competitive with conventional internal combustion engine power plants. One of the major contributing factors to cost at this time remains precious metal loading at the electrodes (particularly at the cathode). A higher heat operating PEM would increase electrochemical activity at the electrodes and diminish precious metal catalyst requirements; however, a greater need to humidify the polymer membrane would be required; not only because of increased dehydration due to exothermic heat, but because of the increased ionic current flow. The DOE states progress has been made in developing fuel cell membranes that are capable of operating at 120 degrees C., or above, toward lessening this problem; however, greater humidification remains an issue at the anodic side of the polymer membrane. This drying of the membrane (caused by both exothermic heat, and electroosmotic travel of water molecules being carried by H+ cations (protons) across the polymer membrane) causes the condition of fuel side membrane dehydration to form at the anode-side of the electrolyte preventing ions (protons) from passing through the membrane to the cathode. With reference to another variation of prior art in U.S. Pat. No. 4,678,724, a relevant fact, pertaining to a specific benefit of the present invention, is stated: “ . . . drying of the hydrogen side of the membrane may be substantially reduced, even at high cell densities and high battery output, by cooling the hydrogen side of the membranes sufficiently to establish a temperature gradient which causes back migration of water from the cathode to the anode side to alleviate drying.” Although this cooling and resultant moisturizing has proven a benefit to the PEM, it has not been fully realized in prior art with respect to the improvements in the present invention; and has therefore only offered a component of membrane hydration at the anode. In addition, it has been a practice, particularly in PEM fuel cell technology, to entrain water into the fuel supply to help re-hydrate the membrane; however, it is found that over hydrating this way can cause a moisture film to build up at the anode-electrode surface; hindering fuel contact with the said electrode, limiting the amount of water that can be entrained with the fuel to benefit the said membrane.

Another area needing improvement within conventional fuel cell systems, of which the present invention pertains, is the un-even “mal-distribution” of fuel at the anode, causing a condition known as “hot spots” that diminish reactant fuel diffusion performance at the anode side. This problem is aggravated, in prior art, by the high cost and by the limited performance and capability of minute and complex flow-channels, by necessity, engraved into carbon backing plates (used in flat plate fuel cells) to distribute reactant to electrodes (and to carry by-product water away) within a closed pressure delivery system.

Another cost and performance issue, of which the present invention pertains, is the air management required in conventional systems. The DOE states: “Pressurization of fuel cells will result in higher power density and lower cost.” This statement would largely be directed to water management (dehumidifying the cathode) and with regard to the inherent slow kinetics at the cathode; noted by the DOE, to be as much as a hundred times slower than at the anode. In a conventional closed pressure system, air (02), as stated by the DOE, should be delivered to the cathode at pressures of at least 3 atmospheres. However, the parasitical drag, cost, bulk, capacity and reliability of the compressors being developed, to provide such, remain issues. For example, the durability of such compressors depend on effective lubrication for friction and wear reduction in critical components, which according to the DOE, the lubricants needed, with respect to present technology, can contaminate and poison the electrodes in the fuel cell stack. Although critical components are being developed, the durability, cost, bulk, capacity and the parasitical power drag on the overall system output, remain issues.

Water removal at the cathode-electrode surface in conventional pressured stack systems has been largely attempted by means of high pressured air, forced at the cathode side, such not only to provide (02) reactant (as described above to increase reaction “kinetics”) but to carry water out of the described convoluted and minute flow-channels, sculpted within the high pressure system. Because of the above limitations and problems with specialized high compressor systems to accomplish this “dehumidification of the cathode” within such high pressure systems and the resulting cost and performance limitations of the minute flow-channels, there remains a continuing need for further improved systems that will offer effective water removal from the cathode while offering any desired level of (02) delivery. It is known, with the desired higher density output of any fuel cell system comes the inherent problem of staying ahead of an over humidified and moisture ridden cathode. Therefore, efficiently removing water instantly as it is formed, and simultaneously at the entire cathode-electrode surface, is essential in any effective water management effort; thus, preventing the film build-up and flooding (dead-spots) that occur at cathode-electrode surfaces.

Such efforts will offer the benefit of smaller systems i.e., incorporating less sq. area of active electrode surface; and therefore, smaller requirement for precious metal loading for catalyst; and therefore providing greater productive output, at less overall cost.

### SUMMARY OF THE INVENTION

A principle object of the invention is to provide a new concept in a fuel cell system which makes it possible to achieve optimum reactant gas diffusion performance, excellent water management and removal performance, controlled cooling of fuel side electrode and offering increased humidification to the benefit of the fuel side of a Polymer Electrolyte Membrane (PEM).

The invention as it pertains to PEM fuel cell technology provides a novel mechanism and function for the improved (and accelerated) reactant distribution within the fuel cell; which will substantially reduce the occurrence of harmful ‘hotspots’ (caused by uneven or mal-distribution of fuel) or the moisture ridden ‘dead spots’ in active electrode surface areas; while increasing overall electrochemical activity over a given square area of said active electrode surfaces, per second of operation. As well, the exothermic heat generated at the anode may be maximized for greater electrochemical activity while minimizing the accompanying negative drying effect on the fuel-side of the polymer membrane in a PEM fuel cell. Further, the benefits resulting from the novel function of the invention promise to reduce precious metal catalyst requirements in a PEM fuel cell system.

It is conceivable certain aspects of the invention may also provide benefit to other fuel cell technologies that comprise an anode, electrolyte and cathode in relationship thereof. For example: in a Solid Oxide Fuel Cell (SOFC) system the novel cooling capacity of the present invention may offer benefits at the operating stage of a SOFC system, to hold an optimum temperature; and at the start up stage, offer an accelerated, therefore faster warm-up; which may be of use in transportation applications. Such a system and others, promise to reduce or eliminate precious metal catalysts; and or, provide for the use of a variety of fuels; including fuels which may not involve the reforming of hydrogen, such as direct methanol fuel cells (DMFC), etc.

The present invention (applied to a PEM) will forward the advantages of more effective water removal, better reactant distribution, greater anodic-side cooling and hydration, and all the advantages of pressure density at the cathode-electrodes, but without the disadvantages of providing high compression pressure in a fuel cell system. The technical features of the invention promises to largely if not completely replace the costly high pressure delivery compressor systems and the minute limited channelling means within contemporary PEM fuel cell plate stacks that require costly construction to accommodate high pressure delivery (such technology at this time being driven by transportation applications) with what is essentially the accelerated delivery of the electrode surfaces to reactant (rather than the other way around as per compressor forcing reactant past electrodes). This can be accomplished, according to the present invention (without lubricant-contamination issues derived from high force compressors; and without other seal or bearing issues inherent with moving parts) by way of providing a rapidly repeating sealed movement, that may be described as a reciprocating (i.e., rapidly repeating back and forth, or up and down motion, occurring between at least two points along any definable plane or a straight line) or like (micro) vibrational motion-movement; or with reference to alternative embodiments and electrode shapes involving a radius or an arch, such repeating movement may be described as an oscillating motion-movement (i.e., any rapid to and fro, occurring between at least two points of a definable radial arc) or like (micro) vibrational motion-movement. The electrode surfaces having the described motion-movement at any desired amplitude (i.e., range of fluctuation) of such movement; and frequency (i.e., velocity or speed of repetition) of such movement, will effectively provide increased contact and exposure opportunity per second by agitating the electrodes through, within, the reactant, at low or ambient pressures, rather than by way of said high compression delivery technology and the severe parasitical power drag (including bulk, weight and expense) attempting to thrust-force reactant into limited minute and convoluted flow channels, normally engraved into carbon current collectors in conventional fuel cell stacks, to be brought into contact with electrode surfaces; such, higher compression delivery also being needed to provide for any water removal and dehumidification at the moisture ridden cathode. Again, the type of described repeating (or vibrational) movements above will wholly depend on the shape and design of the electrodes and may further involve an alternating or combination of said motion-movements or resulting gyro motion-movement, or like (micro) vibrational motion-movement of such.

To further explain, according to the invention, greater reactant contact density per square area of the active electrode surface is achieved by the described reciprocating (or oscillating) or like (micro) vibrational motion-movement of the electrodes, at low or ambient pressures; effectively, doing much the same as an agitator in a washing machine, increasing the contact opportunity of soap and water to the surface of clothes. The reactant, by the described reciprocating (or oscillating) or like (micro) vibrational motion-movement of the electrodes at any effective amplitude, causes both the fuel reactant and (02) reactant, within respective chambers, to be evenly and aggressively distributed and exposed across the respective electrode surfaces at higher speed and effectiveness; rather than attempting to achieve in a contemporary pressure stack, any equivalent contact delivery of reactant by thrust, forcing reactant through minute channels (creating severe and unnecessary density) in a closed high pressure static stack system. In other words, it is possible to agitate (i.e., reciprocating (or oscillating) or like (micro) vibrating at high speed frequency of movement and at effective amplitude or range of movement) an electrode through reactant, faster and with less power drag, than to compressor-force reactant through a contemporary static system, to attempt greater contact opportunity per second between an electrode surface and reactant. The benefits of described motion-movement do not end there, particularly when the removal of water at the cathode-electrode surface and cooling at the anode is more effectively accomplished by the same reciprocating (or oscillating) or like (micro) vibrational motion-movement. Further, contemporary compressor force capabilities will not be able to attempt to duplicate such effect, presented by the invention, by way of contemporary force compression of reactant without providing for (02) reactant to meet fuel (H2) reactant at near or equal pressures.

It has been noted in PEM fuel cell systems, that pressure differences between the anodic oxidation area (fuel side) and the cathodic reduction area (02 side) of the fuel cell should be slightly different, with the cathodic area being at the higher pressure for better electrochemical result. However, because performance at the cathode is much slower than performance at the anode, there is a benefit to increasing kinetics at the cathode relative to the anode. The DOE states, concerning electrode performance: “kinetics at the cathode is ˜100 times slower than at the anode.” The effect of said reciprocating (or oscillating) or like (micro) vibration motion-movement of the electrodes at a high speed (frequency of motion) and at an effective amplitude (range of motion), according to the invention, will effect all the described benefits, but will simultaneously allow for ideal pressure differences (necessary, for a Polymer Electrolyte Membrane to avoid stress or rupture) even while accessing any desired provision of (02) at the cathode-electrode surface. As a result, the higher kinetics at the cathode will allow for better fuel hunger at the anode side; as it is known that overall fuel cell performance is sensitive to oxygen depletion (reduced (02) to electrode contact (pressure) in contemporary static stacks) at the cathode.

In operation, according to the invention, the anode, electrolyte and cathode (i.e., AEC assembly unit) is powered to have described motion-movement as one bonded assembly unit (and with a plurality of like units), at an amplitude (i.e., distance of movement between two points of movement) and frequency (i.e., speed of back and forth reciprocating (or oscillating) movement between two points of movement) that will specifically benefit the anode, electrolyte and the cathode to increase overall electrochemical reaction and performance. More specifically, the anode and cathode are constructed to permanently sandwich an electrolyte; and are conceived to be a distinct concomitant (or bonded) assembled unit; operating with a plurality of like units within a fuel cell system. This bonded assembly unit (AEC assembly unit) would include an electrolyte sandwiched by an anode-electrode at one side and a cathode-electrode at the other side, including any interconnect and or casing materials of which will provide the ridged structural strength to allow the described motion-movement of such; as well, any electrical-chemical enhancement (including electrical connectivity) within said AEC assembly unit.

According to the preferred embodiment of the invention the anode-electrode, electrolyte and cathode-electrode, including any inter connect and or casing materials there of, are constructed in a flat plane shape (i.e., flat, planar shape; with a square or rectangle perimeter) and mounted at and supported by a gasket like mount with a motion or shock like absorbing quality, of which is at opposite fixed to a generally stationary housing (and or sub-housing and or otherwise supporting structure). The said mount(s) comprising a component having a give and take function capability at the outer edge or perimeter of the said AEC assembly unit allowing for the give and take (or vibrational) motion-movement of same; while also acting as the seal mechanism separating and containing the anode-oxidation chamber area from the cathode-reduction chamber area at opposite sides of said AEC assembly unit. The AEC unit (with reference to preferred embodiment) is engaged to effect described reciprocating or similar (micro) vibrational motion-movement by a mechanism of which would comprise an electric motor (transducer) operating to produce such motion-movement with little parasitical drag from the systems electrical output (or charge to battery) during operation and by battery at start up.

To further explain the operation of preferred embodiment, the AEC assembly being a plane shape (i.e., flat, planar shape; with a rectangular or square perimeter) has a described reciprocating, or like (micro) vibrational motion-movement adjacent to a stationary fuel delivery and heat exchanging means, or wall. The space between the surface of the said stationary heat exchanging means or wall and the anode-electrode surface side of the AEC assembly unit is the oxidation area of a PEM fuel cell system. The anode is benefited by the described rapid reciprocating (or like vibrational) motion-movement of the AEC assembly; in that, such motion-movement is providing for more efficient and even fuel dispersion and distribution; and greater fuel contact opportunity, per second, at the entire active surface of the anode; alleviating the condition known as “hotspots” at the anode. The described reciprocating (or like vibrational) motion-movement of the anode surface, i.e., AEC assembly, according to the invention will provide for greater moisturizing to the anode side of the electrolyte membrane by way of the rapid and direct cooling of the anodic surface. As the described reciprocating (or like vibrational) moving anodic surface (or AEC assembly) is passed over a stationary cooling ridge (or alternatively passed over cooling ducting disposed within said stationary heat exchanging means or wall) heat is rapidly removed from the traveling anodic surface where it is generated, by heat exchange (radiator) outside the system. This rapid and efficient heat removal, through the said cooling means, will reduce electroosmotic travel (moisture loss) from the anode, which occurs through the electrolyte, to the cathode. Such efficient and rapid cooling will serve to draw essential moisture back from the cathodic side, to the anodic side of the electrolyte, for continual hydration (moisturizing) of the PEM. Such back diffusion of water has been shown to provide some anode-side re-hydration in prior art. However, according to the invention, the high frequency (speed of reciprocating movement) of the AEC assembly will offer greater, more direct and rapid cooling; and therefore more re-hydration to the PEM at the fuel side, even in higher current density operation.

As well, in contributing to further humidification of the PEM at the anode, it is customary, in contemporary PEM fuel systems to entrain water into the fuel stream to provide moisture vapour to re-hydrate the fuel side of the membrane; although this hydration has not been sufficient, alone, in higher current density operation, to counter the transport of water molecules that each proton carries across the membrane (during oxidation at the anode side), it has been a contributing factor in prior art to moisturize the membrane. However, the amount of water which can normally be fed into the fuel stream is limited; that is, with too much water vapour entrained into the fuel, a water film tends to form over the anode-electrode surface preventing the fuel from a fully exposed active surface. The high frequency (speed of reciprocating movement) of the AEC assembly will serve to significantly diminish the negative effects of any necessary hydration of the fuel; in that, the build up of water film that would tend to form in prior art systems would be more evenly and instantly dispersed over the entire anode-electrode surface by centrifugal forces; to the extent more water vapour may be able to be fed into the fuel stream with less negative effect; or less water vapour having better effect.

A further benefit will occur as the gaseous fuel flow travels between the cooling ridges along the length of the ridges and the said fuel is cooled by the said ridges; while warmed at the area between the ridges, which is the oxidation area relating to the traveling anode-electrode; such, providing for some condensation and therefore some additional humidifying effect within the oxidation area; to the specific benefit of a PEM fuel cell system application.

The space between the cathode-electrode surface of the said AEC assembly and the inside stationary cathode wall (or V-shaped grooves) of the stationary housing is the reduction area of the fuel cell system. With reference to the above, the described reciprocating (or like vibrational) motion-movement and high frequency (i.e., velocity of such reciprocating movement) of the said AEC assembly will offer further specific advantage and benefit to the cathode side of the said AEC assembly. By means of centrifugal forces, the reciprocating surface of the cathode will throw off excess water instantly, as it is formed, preventing moisture film build up and any resulting “dead spots” over the entire cathodic electrode surface. In addition, such reciprocating (or like vibrational) motion-movement at high frequency (i.e., high velocity of described reciprocating movement) will serve to keep the cathodic reduction area dehumidified; and to increase reactant (02, or ambient air) contact opportunity and availability at the entire active surface area of the cathodic electrode, per second of operation; such providing for a very effective and efficient cathodic water separation and removal system.

It is further conceivable according to the invention that the cathode electrolyte and anode (AEC assembly unit(s)) in an alternative embodiment of the invention may be constructed as generally cylindrical or tubular shapes; multiple units, sharing a single source (mechanism) of which effecting the described reciprocating motion-movement (along a straight line that is the length of said cylindrical or tubular shape); or described oscillating motion-movement (along the radial arc of the said cylindrical or tubular shapes); or a similar vibrational (micro) motion-movement of either; or a combination of such movements resulting in a gyration or similar vibration (micro) motion-movement. Such embodiment, sharing a single housing and or a supporting infrastructure; a single source of reactant and cooling medium, common manifold and entry and exit apertures of the same, in a single system.

It is also conceivable according to the invention that the cathode, electrolyte and anode or (AEC assembly unit) in another differing embodiment of the invention could be constructed as an circular plate or disk shape wherein a plurality of such are fixed at their axis center on a shaft, spaced there on and engaged by a mechanism of which effecting described oscillating (i.e., any rapid to and fro, occurring between at least two points of the radial arc of the plate or disk shape) or similar vibrational (micro) motion-movement (or alternatively said plate or disk shaped AEC assembly unit(s) mounted to oscillate or like (micro) vibrate, accordingly, around a stationary shaft), allowing for, in either design, a stationary reactant delivery means, positioned between each said motion-moving AEC assembly units to provide for reactant ducting, delivery and cooling medium; and sharing common manifold and entry and exit apertures of the same, in a single system.

It is further conceivable, that the oxidation and or reduction chamber area(s) in a further alternative embodiment may partake in said described motion-movement(s) if said chamber area(s) are affixed to said motion-moving AEC assembly unit; such an alternative embodiment may offer some advantages over static prior art.

The above and other objects, features and advantages of the invention will become more apparent from the following detailed descriptions when taken in conjunction with the accompanying drawings in which the preferred embodiments and other descriptions are illustrated.

### BRIEF DESCRIPTION OF THE SEVERAL VIEWS

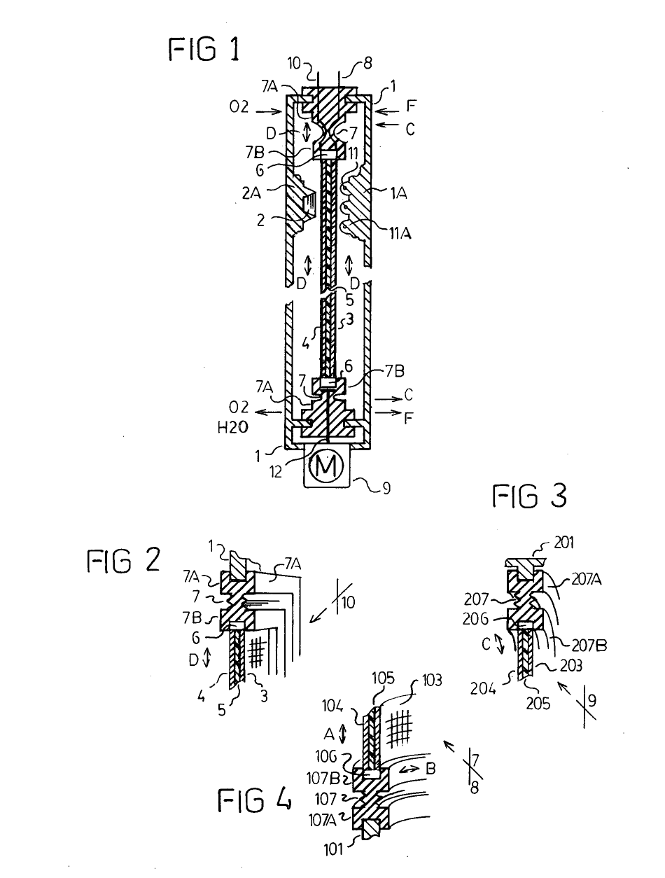

FIG. 1 is a cross sectional side view of a single cell, plane (or flat, planar shape; with a rectangle or square perimeter) shaped AEC assembly unit (3, 4 and 5); taken along lines 1-1 in FIG. 10.

FIG. 2 is a cross sectional and partial perspective side view of a right angle (corner) area of a plane (or flat, planar shape; with a rectangle or square perimeter) shaped AEC assembly unit (3, 4 and 5); and showing a hatched view of a portion of a motion absorbing mount 7 and its relationship to said AEC assembly unit; taken along the line of view represented by broken arrow marked 2 in FIG. 10.

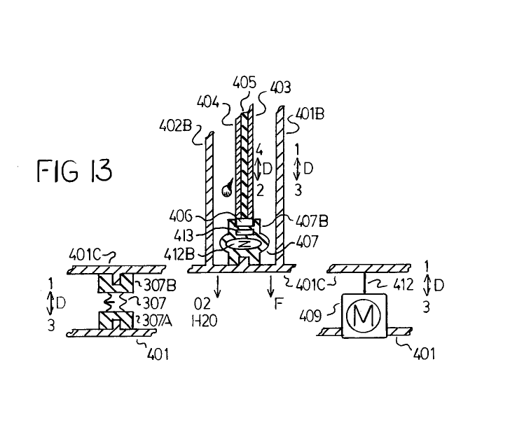

FIG. 3 is a cross sectional and partial perspective side view of an alternative disk or plate shaped AEC assembly unit (203, 204 and 205); and showing a hatched view of a portion of a motion absorbing mount 207; taken along lines 3-3 in FIG. 9.

FIG. 4 is a cross sectional and partial perspective side view of an alternative cylindrical or tubular shaped AEC assembly unit (103, 104 and 105); and showing a hatched view of a portion of a motion absorbing mount 107; taken along lines 4-4 in FIGS. 7 and 8.

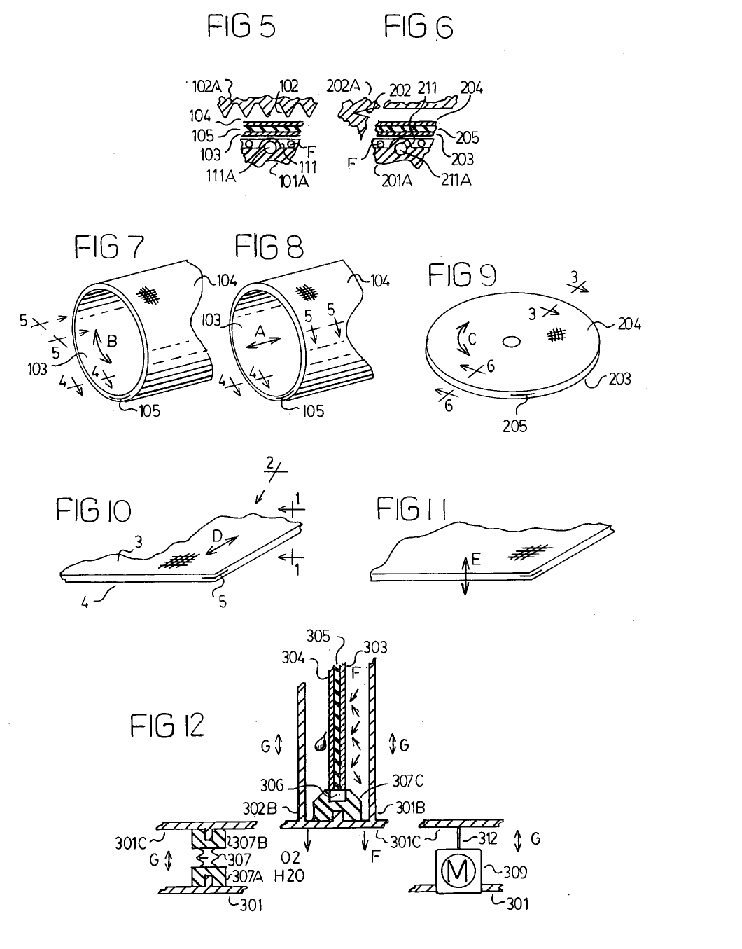

FIG. 5 is a partial cross sectional side view depicting relationship between a cooling means 101A and an AEC assembly unit (103, 104 and 105); and as such may relate to fuel ducting (F); and (02 and H20) V-shaped grooves 102; taken along lines 5-5 in FIG. 7 or 8.

FIG. 6 is a partial cross sectional side view depicting relationship between a cooling means 201A and an AEC assembly unit (203, 204 and 205); and as such may relate to fuel ducting (F); and a differing cathode wall 202A and edge gutter channelling 202; taken along lines 6-6 in FIG. 9.

FIG. 7 is a partial perspective view of a cylindrical or tubular shaped AEC assembly unit (103, 104 and 105); the double headed arrow depicted marked (B) represents an oscillating motion-movement, and or like (micro) vibrational motion-movement; taken along the line of view represented by broken arrow marked 7 in FIG. 4.

FIG. 8 is a partial perspective view of cylindrical or tubular shaped AEC assembly unit (103, 104 and 105); the double headed arrow depicted marked (A) represents a reciprocating motion-movement, and or like (micro) vibrational motion-movement; taken along the line of view represented by broken arrow marked 8 in FIG. 4.

FIG. 9 is a perspective view of a flat circular disk or plate shaped AEC assembly unit (203, 204 and 205); the double headed arrow depicted marked (C) represents an oscillating motion-movement and or like (micro) vibrational motion-movement, as it relates to the flat circular disk or plate shape; taken along the line of view represented by broken arrow marked 9 in FIG. 3.

FIG. 10 is a partial perspective view of a portion of a plane (or flat, planar shape; with a rectangle or square perimeter) shaped AEC assembly unit (3, 4 and 5); the double headed arrow depicted marked (D) represents a reciprocating motion-movement and or like (micro) vibrational motion-movement; taken along the line of view represented by broken arrow marked 10 in FIG. 2.

FIG. 11 is a partial perspective view of a portion of any flat surface AEC assembly unit; the double headed arrow depicted marked (E) represents a reciprocating motion-movement with alternative direction of said motion-movement being perpendicular to the plane of said flat surface.

FIG. 12 is a partial cross sectional side view of an alternative single cell plane (or flat, planar shape; with a rectangle or square perimeter) shaped AEC assembly unit (303, 304 and 305) with attached and fixed oxidation and reduction chambers partaking in described reciprocating motion-movement with said AEC assembly.

FIG. 13 is a partial cross sectional view of a single cell plane (or flat, planar shape; with a rectangle or square perimeter) shaped AEC assembly unit (403, 404 and 405) wherein oxidation and reduction chambers partake in described reciprocating motion-movement; however, the motion-movement of said AEC assembly is an inertial, secondary, motion-movement, in response.

### DETAILED DESCRIPTION OF THE INVENTION

Referring to drawing pages (1, 2 and 3 of 3) and in particularly to FIG. 1, a single cell, preferred, plane shaped (i.e., flat, planar shape; with a rectangle or square perimeter) embodiment is depicted in an enlarged cross sectional view from the side; and taken along the lines 1-1 in FIG. 10 (note, parts depicted in FIGS. 1-13 may not be relational in scale to other parts for the purpose of clarity). A stationary structure 1 is the stationary structural support and or housing or sub-housing of the depicted single fuel cell. The stationary structure 1, supports (in a fixed position) the motion absorbing mount 7; of which comprises a give and take motion absorbing quality, function and capability (such as found in a type of pliable, elastic rubber material) allowing for the reciprocating (up and down) motion-movement of the electrolyte 5 (with the combined anode-electrode 3 and the cathode-electrode 4) including any interconnect material and or structural supporting casing material(s) that will comprise the AEC assembly unit 3, 4 and 5.

The motion absorbing mount 7, surrounds the outer edge or perimeter of the said AEC assembly unit (3, 4 and 5); and acts further as a seal mechanism, and type of acting gasket, between the anode-oxidation and cathode-reduction chambers; containing each chamber while allowing for the rapid repeating reciprocating (up and down) motion-movement, depicted by double headed arrows marked (D) in FIG. 1 (each double headed arrow showing the same described movement). The motion absorbing mount 7, being a first part allows for a reciprocating (up and down) motion-movement of an attached and sealed second part (i.e., AEC assembly unit 3, 4 and 5), relative to a stationary, supporting, attached and sealed third part (i.e., stationary structure 1, housing or sub-housing).

The AEC assembly unit (3, 4 and 5) is engaged by a motion-movement source mechanism of which may comprise an electric motor or transducer 9 (i.e., an electric motor that converts electrical energy into the described motion-movement (represented by encircled M symbol)); fixed to stationary structure 1 (housing or sub-housing); operating to transmit and effect via means 12, the described motion-movement to the AEC assembly (3, 4 and 5) with little parasitical drag from the systems electrical output (or charge to battery) during operation and by battery (outside system) at start up.

To benefit a plane shaped (i.e., flat, planar shape; with a rectangle or square perimeter) AEC assembly unit (3, 4 and 5), as depicted in FIGS. 1, 2 and 10, the motion-movement would most appropriately be a rapid reciprocating motion; and or a similar, or like (micro) vibrational movement (such, being defined as any repeating back and forth, or up and down motion occurring between at least two points along any definable plane or straight line). The similar or like (micro) vibrational movement, having a shorter range of motion (amplitude) between at least two points.

The motion-movement source mechanism (9 and 12) will be designed to offer the described motion-movement to multiple AEC assembly units (3, 4 and 5) within a larger stationary structure 1 (housing or sub-housing). One alternative thereof would be transmitting described motion-movement from a single source transducer devise (i.e., electric motor that converts electrical energy to described motion-movement) transferring (electrical) power and or (mechanical) force and or (inertial) movement, from one part of said mechanism (i.e., transducer 9) through and or to another part (i.e., motion moving portion 7B, of said motion absorbing mount 7) via mechanical transmission 12 (including mechanical components); and or electrical transmission 12 (including electrical components); and or inertial force transmission 12 and or 412B (including inertial components and or embedded weights including spring reaction capabilities (particularly related to FIG. 13 descriptions)).

The transmission mechanism 12, as depicted in FIG. 1, may act as a mechanical plunger effecting greater amplitude, (range, or distance) of motion-movement, than what would be necessary to accomplish a micro amplitude in a described vibrational motion-movement. Alternatively, and particularly with regard to a described (micro) vibrational motion-movement, transmission means 12, may be an electrical transmission means, transmitting electrical power to a (micro) vibrating transducer means; alternatively, attached and fixed to a moving portion 7B of the motion absorbing mount 7 (or alternatively with the stationary portion 7A); and wherein the transducer (or a portion of it) communicates described (micro) vibration to the AEC assembly unit (3, 4 and 5) located within the motion absorbing mount 7. It is further conceivable that an AEC assembly (3,4 and 5) may be appropriately weighted at the perimeter (or radial) edges 7B or at perimeter frame 6; to better enable said AEC assembly unit to respond to a described motion-movement if such were simply applied (via a source transducer 9) to a sub-housing 1 containing said AEC assembly unit; said AEC assembly unit being mounted to a motion absorbing mount 7 (as may be contemplated in FIG. 2; and depicted in FIG. 13) allowing for the said inertial force reaction and thereby effecting the motion-movement (D) of the AEC assembly; from a motion-source applied to (simply making contact with) the outside wall or platform of a sub-housing 1.

It should be noted, the described motion-movement can be sourced and transferred to the AEC assembly unit (3, 4 and 5) by any number and various ways. Additionally, transducers (including vibrational motion producing mechanisms) and means of transmission are presently manufactured in great variety of design, size and shape; and as well, may be mechanically or electrically applied to effect the described motion-movement(s) to the AEC assembly unit (3, 4 and 5) by way of many differing means. FIG. 1, depicts the transmission of described motion-movement from a source (transducer 9), to the AEC assembly unit (3, 4 and 5), by a representative line 12, drawn to represent a transmitting connective relationship (mechanical or otherwise) from a motion-movement source (transducer 9), to the moving portion 7B, of the motion absorbing mount 7; of which (with reference to FIG. 1) the moving portion 7B, is directly attached in a sealed connection to the AEC assembly unit (3, 4 and 5).

To further explain the function of the disclosed fuel cell with reference to FIG. 1: the stationary structure 1, supports (in a fixed position) the anode side fuel reactant ducting (F) (not shown in FIG. 1; however, represented in FIG. 5); and in this embodiment a cooling delivery means 1A (i.e., wall or structural body); of which comprising cooling ridges 11, which contain pressurized channelling 11A, for coolant-medium (C), to provide heat exchange relief from the anode. The said cooling means 1A, of which comprising cooling ridges 11, is only partially depicted in FIG. 1; however, such will extend adjacent over the entire anode-electrode surface as is (partially) depicted. As the AEC assembly unit (3, 4 and 5) rapidly and repeatedly travels up and down (as depicted by the said double headed arrows (D) in FIG. 1,) the low pressure fuel flow (F), pressurizes the anode-oxidation chamber (the anode-oxidation chamber, identifiable as the space adjacent and between the anode-electrode 3, and (between) the said cooling ridges 11); the fuel being exposed to the accelerated hunger of the rapid reciprocating (up and down) lapping motion of the anode-electrode 3.

The rapid reciprocating (up and down) motion-movement of the AEC assembly unit (3, 4 and 5); will alleviate the condition known as “hotspots” at the anode-electrode surface caused by uneven, and mal-distribution of fuel reactant. This condition will be effectively eliminated by the described motion-movement; such agitation, in effect causing greater dispersing and distribution of the reactant and creating greater contact opportunity per second at the entire surface of the anode-electrode 3.

Further, the cooling ridges 11, are acting to cool the traveling surface of the anode-electrode 3, serving effectively, to draw back moisture lost with proton travel carried through a Polymer Electrolyte Membrane 5 (or PEM). Note, FIGS. 1 and 5 partially show the AEC assembly unit (3, 4 and 5) and its relationship proximity to the cooling ridges 11 (proper scale is not intended to be depicted for clarity). To further explain the benefits of a cooling exchange means being disposed adjacent the described motion-movement of the AEC assembly unit (3, 4 and 5); is that, each proton passing through the electrolyte 5 (PEM), carries with it multiple moisture molecules, as detailed in the summary of invention. As the anode-electrode 3 (of the AEC assembly unit (3, 4 and 5)) is passed over a cooling ridge 11, heat is removed from the anode-electrode surface 3. This rapid heat removal reduces the electroosmotic travel (moisture loss) carried from the anodic oxidation side to the cathode-reduction side. Accordingly, as the anode-electrode surface 3, is maintained at a lower temperature, relative to that of the cathodic-electrode surface 4, moisture draw back will help to keep the anode side of the electrolyte 5 (PEM) hydrated and functioning; particularly, with the increased fuel reactant contact and reaction at the anode-electrode surface 3. Other resulting moisturizing benefits are noted and explained in the Summary; and include the benefits of fuel reactant (F) traveling between and along the length of the cooling ridges 11.

The described rapid cooling is achieved by the heat exchanging means, i.e., pressurized coolant channelling 11A, disposed within the length of the cooling ridges 11. The cooling medium (C), having been cooled in a heat exchange system (radiator) outside the fuel cell system, re-enters the stationary structure 1 (housing or sub-housing) shown in FIG. 1 (i.e., entry arrow marked (C)); to pass through each cooling ridge 11, under pressure via cooling pump (not shown) through the continuous and connected coolant channelling 11A, and then to exit (i.e., exit arrow marked (C)).

Depending on the frequency (i.e., velocity or speed of the repetition of the described motion-movement) of the AEC assembly unit (3, 4 and 5), cooling will be an important benefit presented by the described motion-movement. For example, a further efficiency in cooling capability may involve the relationship of the amplitude of motion-movement and the distance or space between the cooling ridges 11; in that, any specific area of the anode-electrode surface 3, may travel back and forth over a cooling ridge, as the distance between each cooling ridge 11, may approximate the amplitude of motion (i.e., distance of alternating motion, occurring between at least two points). Even within a (micro) vibrational back and forth motion-movement the cooling ridges 11 may be constructed closely adjacent to each other to affect the described added cooling benefit. The scale of FIG. 1, although not drawn to reflect accurate relational scale, does reflect a possible relationship of amplitude of movement (as depicted by double headed arrows (D)) with that of depicted space between the cooling ridges 11.

At the opposite side of the AEC assembly unit (3, 4 and 5) the same described motion-movement is benefiting the cathode side; in that, greater electrochemical activity is also being achieved by the increased (02) reactant contact opportunity per second at the cathode-electrode surface 4. In addition, the centrifugal force of the rapidly reciprocating (up and down) motion (of the AEC assembly unit 3, 4 and 5) will throw off water as it forms, preventing water film build up at the entire cathode-electrode surface 4, preventing the crippling cathodic condition known as “flooding” at the cathode; of which prevents contact of oxygen gas (02), with the cathode-electrode surface 4; reducing electrochemical reaction.

In FIGS. 1 and 5, V-shape grooves 2, are depicted at the cathode wall 2A; to capture and retain away any excess water build up from cathode-electrode surface 4, and to allow said water to exit (i.e., arrow marked 02 and H20 in FIG. 1) leading same out of the cathode-reduction chamber (the cathode-reduction chamber, identifiable as the space adjacent and between the cathode-electrode surface 4, and the cathode wall 2A, and or V-shape grooves 2).

With reference to FIG. 1, the (02) reactant inters the cathode-reduction chamber through ducting, indicated by arrow marked (02); said ducting supported directly or indirectly by stationary structure 1 (housing or sub-housing). The V-shaped grooves 2 may serve to guide (02) reactant through the cathode-reduction chamber at equal or slightly higher pressures than fuel reactant at the anode side. Only a slight pressure force of (02) will help to carry water down said V-shaped grooves 2; while feeding (02) reactant to the hungry motion-moving electrode surface 4; the (02) depleted reactant and water exit chamber (i.e., arrow marked 02 and H20).

If hydrogen is the fuel reactant (F) and a Polymer Electrolyte Membrane 5 (or PEM) is employed (as opposed to other applications discussed in the summary); then said hydrogen, supplied to the described motion-moving anode-electrode surface 3, will be converted into hydrogen ions at the catalyst enriched surface of the anode-electrode 3, by the loss of negatively charged electrons. In other words the anode-electrode surface 3 electrochemically reacts with the hydrogen fuel (reactant) separating the hydrogen negatively charged electrons from the positively charged protons. The positively charged protons (hydrogen ions) are drawn and move through the electrolyte 5 (PEM) to the other side of the AEC assembly unit (3, 4 and 5); that is, to the (catalyst enriched) cathode-electrode 4. The electrolyte 5 (PEM), must be somewhat humidified (especially at the ever drying anode side) in order to effectively allow this proton migration through the electrolyte 5 (PEM). Simultaneously, the said negatively charged electrons released (from the hydrogen) during the oxidation process are drawn and move to the external circuit 8 leading to electrical load outside the system. This circuit 8, communicates from the anode-electrode surface 3, wherein a current collector, being disposed across the anode-electrode surface 3, as a comprised (bonded and contributing structural) member, conducts the negatively charged electrons from the entire anode-electrode surface 3, to the (electrically connected) perimeter frame or end portion 6, of which is embedded and framed within the electrically insulated and reactant sealed moving portion 7B of the motion absorbing mount 7; and wherein the communication of electrical current (from a motion-moving circuit to a stationary circuit), may be comprised of a flexible or extendable electrical connection (or slacked electrical wire connection) embedded, electrically insulated and expandable within motion absorbing mount 7; effectively, allowing the communication of electrical current from a motion-moving circuit (i.e., moving portion 7B, of the motion absorbing mount 7) to a stationary circuit (i.e., stationary portion 7A, of the motion absorbing mount 7); to thereby communicate electrical current outside described motion-movement; and to external lead circuit 8 leading to electrical load outside fuel cell.

A complete circuit is resulted as the current returns to the fuel cell beginning at the circuit return lead 10. The insulated return current communicates through the stationary circuit (i.e., stationary portion 7A, of the motion absorbing mount 7); to the motion-moving circuit (i.e., moving portion 7B, of the motion absorbing mount 7); through the (return side) of the described flexible or extendable electrical connection (or slacked electrical wire connection) embedded, electrically insulated and expandable within motion absorbing mount 7; and through the (electrically connected) perimeter frame or end portion 6 (at the cathode side) to the cathode current dispenser (i.e., comprised (bonded and contributing structural) member of the cathode-electrode surface 4). To continue, as the negative electrons (current) return and are gained at the cathode-electrode 4 (the reduction chamber area) oxygen (02) is supplied and the positive charged protons (hydrogen ions), having come through the said electrolyte 5 (PEM), having been gained with the negatively charged electrons (returned from the external circuit), and having been combined with the said (02), now forms by-product water (H20) at the cathode-electrode surface 4; completing the electrical circuit and the electrochemical reaction of the fuel cell.

The motion absorbing mount 7, shown at the top of the FIG. 1, is depicted as fully extended (in a first of a (back and forth) reciprocating motion) showing the described, flexible or extendable electrical connection means, extended with the amplitude of said reciprocating motion; and simultaneously at the lower portion of FIG. 1, the motion absorbing mount 7, at opposite end (of view) is consequently shown compressed and contracted, with the absorption of the same first of a (back and forth) reciprocating motion-movement of the AEC assembly unit (3, 4 and 5).

To further describe the AEC assembly unit (3, 4 and 5), as a single cell, relating to FIGS. 1-13, it is envisioned said AEC assembly to be a distinct concomitant (or bonded) unit, wherein the thickness of the same comprises the following: a porous anode-electrode 3, in fixed intimate-electrical contact with an electrolytic member 5 at the under side of said electrode 3 and at the opposite surface side of same, exposable to fuel reactant (F); said electrolyte material 5 (PEM) being suitable for transporting ions between said anode and cathode; a porous cathode-electrode 4, in fixed intimate-electrical contact with said electrolytic member 5 (PEM) at the under side of said electrode 4 and at the opposite surface side of same, exposable to (02) reactant. And (with specific reference to FIGS. 1-11 and 13) wherein the thickness of the same AEC assembly unit (3, 4 and 5) separates two spaces: an anode-oxidation chamber area being a definable space allowing for the described motion-movement of materials acting as an anode 3; and a cathode-reduction chamber area being a definable space allowing for the described motion-movement of materials definable and acting as a cathode 4.

Mesh (or casing) support structures at each side of the AEC assembly unit (3, 4 and 5) may act as a current collector at the anode-electrode 3, side; and a current dispenser at the cathode-electrode 4, side (depending on the composition of the AEC assembly in varying applications) and would therefore need to be made from material(s) which would provide sufficient electrical conductivity (under the conditions of a given reaction) while providing the structural strength required of the AEC assembly (3, 4 and 5). The strength would include: firmly sandwiching and entirely encasing the electrolyte 5 (PEM), from both sides, saving the AEC assembly unit (3, 4 and 5) from any stress of kinetic forces imposed by the described motion-movement; as well as containing any internal pressures of swelling and warping inherent of a PEM electrolyte 5. With reference to FIG. 1, the perimeter frame or end portion 6, structurally frames the AEC assembly (3, 4 and 5), including any interconnect and or said casing materials, serving to tightly bond the AEC assembly (3, 4 and 5) together and securing the overall structural strength and integrity; that the electrolyte 5 (PEM) and or other soft components of the AEC assembly (3, 4 and 5) are held ridged and inflexible; to be effectively engaged in the described motion-movement.

The various interconnect material may include: the anode-electrode 3 mesh support structure in intimate contact with a carbon paper (and or other suitable material or combination thereof), which will line (or comprise) the anode-electrode surface 3, which is bonded to the electrolyte 5 (PEM) from the anodic side. Likewise, the cathode-electrode 4, mesh support structure may make contact with a porous, wet proof graphite sheet (and or other such suitable material or combination thereof), which will line (or comprise) the cathode-electrode surface 4, which is bonded to the electrolyte 5 (PEM) from the cathodic side. Further, to the composition of the said AEC assembly unit (3, 4 and 5), a quantity of suitable catalyst may be deposited where most appropriate. It may be noted, any appropriate material (including the casing, mesh, support structure acting as a contributing electrode) protruding at surface of acting electrodes 3 and 4, will gain maximum electro-chemical effect (interacting with reactant) with described motion-movement.

FIG. 2. Is a partial perspective view of a right angle area of a plane shape (i.e., flat, planar shape; with a rectangle or square perimeter) AEC assembly unit (3, 4 and 5), as described in FIG. 1; and is taken along the line of view represented by broken arrow marked 2 in FIG. 10. Shown is a hatched view of a portion of a motion absorbing mount 7, including the moving portion 7B and the stationary portion 7A, at a slight angle of view, to depict a motion absorbing mount 7 at a right angle portion (one of four corners) of a square or rectangle shaped AEC assembly unit to be mounted and sealed at a four cornered perimeter to a stationary structure 1 (housing or sub-housing); allowing for the described (reciprocating) motion-movement of said plane shaped AEC assembly (3, 4 and 5) represented with double headed arrows marked (D) in FIGS. 1, 2 and 10.

The stationary structure 1 and motion absorbing mount 7 are depicted differently in FIG. 2 than in FIG. 1; in that, FIG. 1 depicts the perimeter portion of motion absorbing mount 7 that described motion-movement is transmitted 12. The perimeter portion of motion absorbing mount 7, that is not in the direction of any described motion-movement(s) is not depicted in Figs. and may be of a thinner and more supple design and quality to allow for the described motion-movement being side to side in relation to its plane (or leading edge) of attachment.

FIG. 10 is a partial perspective view depicting a portion of preferred plane shaped (i.e., flat, planar shape) AEC assembly unit (3, 4 and 5) as described in FIGS. 1 and 2; and is taken along the line of view represented by broken arrow marked 10 in FIG. 2. The depicted double headed arrow(s) marked (D) in FIGS. 1, 2 and 10, represent the direction of described rapid reciprocating motion; and or a similar, or like (micro) vibrational movement (such, being defined as any repeating back and forth, or up and down motion occurring between at least two points along any definable plane or straight line). The similar or like (micro) vibrational movement, having a shorter range of motion (amplitude) between at least two points. The described “plane or straight line” being the flat, planar, (linear) surface of the depicted said AEC assembly (3, 4 and 5).

Multiple like AEC assembly units (3, 4 and 5) may be mounted within a larger stationary housing or sub-housing, sharing a single source of reactant and cooling medium; common entry and exit apertures of the same; and sharing source mechanism(s) of which effecting and transmitting described motion-movements with in a larger system (not shown in Figs.).

FIGS. 4, 5, 7 and 8 depict an alternative shape embodiment design; wherein, the AEC assembly unit may be constructed in a generally cylindrical or tubular shape. The similar parts, or parts performing similar, relatable, or identical functions are here identified with numbers which will differ from those described above by multiples of one hundred; therefore, the following descriptions (depicted in FIGS. 4, 5, 7 and 8) of the differing embodiment will begin here with the 100(s). Similar parts and or functions of the differing shaped embodiment if previously explained or if obvious will not be repeated.

FIG. 4 is a partial perspective view of the said cylindrical or tubular shaped AEC assembly unit (103, 104 and 105) taken along lines 4-4 in FIGS. 7 and 8. FIG. 4 depicts a hatched view of a portion of a motion absorbing mount 107, including the moving portion 107B and the stationary portion 107A, at a slight angle of view. With regard to the said cylindrical or tubular shape AEC assembly unit (103, 104 and 105): the same described linear motion-movement of the plane shaped AEC assembly unit (3, 4 and 5) in the preferred embodiment (i.e., a rapid reciprocating motion; and or a similar or like (micro) vibrational movement (such being defined as any repeating back and forth, or up and down motion-movement occurring between at least two points along a definable plane or straight line; the similar or like (micro) vibrational movement, having a shorter range (amplitude) of motion between at least two points); will apply along the direction of an imaginary straight line passing through the length of a cylindrical or tubular shape AEC assembly unit (103, 104 and 105), as per represented with double headed arrow(s) marked (A) in FIGS. 4 and 8.

Regarding FIGS. 4 and 7, the alternative cylindrical or tubular shaped AEC assembly unit (103, 104 and 105) may be engaged by a motion-moving source mechanism (not shown) of which would effect and transmit a rapid oscillating motion-movement and or a similar or like (micro) vibrational movement (such being defined as any to and fro motion-movement occurring between at least two points along a definable radial arc); the similar or like (micro) vibrational movement, having a shorter range (amplitude) of motion between at least two points. The said motion absorbing mount 107 (with regard to described oscillating motion-movement) will have a side to side (to and fro) give and take capability; thereby allowing for the described oscillating motion-movement, represented by the double headed arrow(s) marked (B) in FIGS. 4 and 7.

Further regarding FIGS. 4, 7 and 8, a combination of such described movements (represented by double headed arrows marked (A) and (B)) resulting in a gyration or similar vibration (micro) motion-movement may be achieved by a source mechanism (not shown) of which effecting and transmitting such to said AEC assembly unit (103, 104 and 105).

Multiple like AEC assembly units (103, 104 and 105) may also be mounted within a larger stationary housing or sub-housing sharing a single source of reactant and cooling medium; common entry and exit apertures of the same; and sharing source mechanism(s) of which effecting and transmitting described motion-movements within a larger system (not shown in Figs.).

FIG. 5 is an enlarged partial sectional view taken along lines 5-5 in FIG. 7 or 8; depicting the relationship between an AEC assembly unit (103, 104 and 105); a cooling delivery means 101A (the structural body of which will be of a bar or cylindrical shape; that is, if fitting within the inside radius of a cylindrically shaped AEC assembly unit as described in FIGS. 4, 7 and 8) comprising cooling ridges 111; and a cathode wall 102A comprising V-shaped grooves 102 (in FIG. 1, said grooves 2, differ in view, as per direction end to end relative to the depiction of the cooling ridges 11). The anode side fuel reactant ducting (F) is shown opening into anode-oxidation chamber delivering fuel reactant (F) between the cooling ridges 111 (of which such depiction may also apply to, what is not shown in FIG. 1; regarding fuel openings (F) positioned between cooling ridges 11).

FIGS. 3, 6 and 9 depict a further alternative shaped embodiment design; wherein, the AEC assembly unit may be constructed in a disk or plate shape (i.e., flat, circular shape). The similar parts, or parts performing similar, relatable, or identical functions are here identified with numbers which will differ from those described above by multiples of one hundred; therefore, the following descriptions of the differing embodiment will begin here with the 200(s). Similar parts and or functions of the differing embodiment if previously explained or if obvious will not be repeated.

FIG. 3 is a partial perspective view of the disk or plate shaped AEC assembly unit (203, 204 and 205); taken along the lines of 3-3 in FIG. 9. FIG. 3 depicts a hatched view of a portion of a motion absorbing mount 207, including the moving portion 207B and the stationary portion 207A, at a slight angle of view. The said disk or plate shaped AEC assembly unit (203, 204 and 205) may be engaged by a motion-moving source mechanism (not shown) of which would effect and transmit a rapid oscillating motion-movement and or similar a like (micro) vibrational movement (such being defined as any to and fro motion occurring between at least two points of a definable radial arc); of which said arc would share a radial-axis with said disk or plate shaped AEC assembly unit (203, 204 and 205) as depicted in FIG. 9. In other words, the (to and fro) direction(s) of the described oscillating motion-movement occur along the curved radius of the circular flat surface of same. Further, the similar or like (micro) vibrational movement, will have a shorter range (amplitude) of motion between at least two said points. The described oscillating motion-movement is represented with double headed arrow(s) marked (C) in FIGS. 3 and 9.

Further with reference to FIG. 3, the said motion absorbing mount 207, will have a side to side turning (to and fro) give and take capability, in relation to the moving portion 207B being fixed and sealed at the radius of the said disk or plate shaped AEC assembly unit (203, 204 and 205); and the stationary portion 207A, being fixed and sealed at the radius of the end portion 6 and stationary structure 1 (and or housing or sub-housing); thereby allowing for the described motion-movement.

FIG. 6 is an enlarged partial sectional view taken along the lines 6-6 in FIG. 9; depicting the relationship between said disk or plate shaped AEC assembly unit (203, 204 and 205) and a cooling delivery means 201A, comprising cooling ridges 211; and a cathode wall 202A comprising (V-shaped groove) edge (gutter) channelling 202 (note, such gutter channelling 202 may apply to any preferred, flat, planar shaped AEC assembly embodiment). The cooling ridges 211 would preferably extend from the radial center of said disk plate shape of the said AEC assembly (203, 204 and 205) to the outer edge of same, where the reactants (F) and (02), cooling (C), and water (H02) would exit the embodiment; after said reactants and cooling having entered from the axis center, or vice-versa.

FIG. 9 is a perspective view of a flat circular disk or plate shaped AEC assembly unit (203, 204 and 205); however, depicting an exaggerated thickness and smaller radial size of same, for purpose of clarity; and is taken along the line of view represented by broken arrow marked 9 in FIG. 3. A motion-moving source mechanism (not shown) may engage a shaft (of which may be contemplated by the opening depicted at the radial center of said AEC assembly unit in FIG. 9) on which multiple identical disk or plate shape AEC assembly units may be spaced, mounted and fixed; to mutually provide the described rapid oscillating motion-movement(s); or alternatively, the said motion-moving source mechanism may engage a motion-moving cylinder (or sub-housing), in which multiple AEC assembly units are spaced, mounted and fixed within same, to gain mutual said motion-movement through the common ridged attachment; or to any acting structural portions of either said shaft or said cylinder. The described (oscillating) motion-movement is represented by double headed arrow(s) marked (C) in FIGS. 9 and 3.

FIG. 11 is a partial perspective view of a plane (i.e., flat, planar shape); or alternatively, a disk or plate shape AEC assembly unit (both shapes having a flat surface in common). The depicted double headed arrow marked (E) represents a described reciprocating motion-movement; however, with an alternative direction of motion-movement being perpendicular to the plane of said flat surface.

FIG. 12 depicts a further alternative embodiment design; wherein the oxidation and reduction chambers are attached, fixed and sealed to a motion-moving AEC assembly unit. The similar parts, or parts performing similar, relatable or identical functions are here identified with numbers which will differ from those described above by multiples of one hundred; therefore, the following descriptions of the differing embodiment will begin here with the 300(s). Similar parts and or functions of the differing embodiment if previously explained or if obvious will not be repeated.

FIG. 12 is a partial cross sectional side view of a single cell AEC assembly unit (303, 304 and 305) fixed and sealed via a perimeter gasket (307C) to and in between an anode-oxidation chamber area (at one side); and (at opposite), a cathode-reduction chamber area; wherein described motion-movement(s) of AEC assembly unit (303, 304 and 305) may, alternatively, include the fixed and attached anode-oxidation chamber (i.e., partially defined by motion-moving wall of same 301B); along with the fixed and attached cathode-reduction chamber (i.e., partially defined by motion-moving wall of same 302B).

The depicted motion absorbing mount(s) 307 may be one of several single positional spot motion absorbing mounts (not a surrounding perimeter motion absorbing mount (i.e., 7, 107, 207 and 407) as described in other embodiments fixed to perimeter of an AEC assembly) positioned between a stationary larger housing 301; and the said motion-moving chambers (301B and 302B), of which hold the fixed, attached and sealed AEC assembly unit (303, 304 and 305). Said motion absorbing mount 307, at one side, comprises moving portion 307B, which is attached and mounted to motion-moving sub-housing (i.e., comprising any outer portion of a wall or platform 301C of which partly defining said chambers 301B and 302B); and at opposite side of said motion absorbing mount 307, is comprised a stationary portion 307A, which is attached to said stationary larger housing 301. Said motion absorbing mount(s) provide the structural support for a described motion-moving sub-housing comprising said oxidation chambers (301B and 302B) and attached AEC assembly (303, 304 and 305).

A motion-moving source mechanism (i.e., transducer 309) is depicted fixed to stationary housing 301 to effect and transmit 312 the described motion-movement, to the said oxidation and reduction chambers (301B and 302B) and the fixed, attached AEC assembly unit (303, 304 and 305) of which, in this embodiment, move together.

The anode fuel reactant (F), and cathode reactant (02), and (H20) is shown exiting respective chambers; however, entry to respective chambers is not shown within the partial lower view of FIG. 12.

The double headed arrow(s) marked (G) represent a described rapid reciprocating motion-movement; however, applied to said oxidation and reduction chambers as well as the combined and fixed AEC assembly unit (303, 304 and 305); fixed and sealed between said chambers at perimeter gasket and seal 307C.

The single headed arrows shown inside the oxidation chamber (depicted in FIG. 12) represent the effect of described motion-movement forces agitating fuel reactant (F), to increase fuel reactant exposure, through kinetic effect of vibrating reactant along with the AEC assembly, as provided by the embodiment. It may be noted, additional benefit may be produced if a weighted agitator were loosely attached inside the oxidation chamber to respond to the described motion-movement (by inertia effect) and resulting in additional stirring and kinetics. Such a mechanism could be designed in a plate like shape or rack adjacent the surface of the electrode and weighted to better respond to the inertial forces there in; resulted from the described back and forth motion-movement; that is, even with the resistance of (the lower) pressures of reactant flow.

A water (H20) droplet is depicted within the cathode-reduction chamber, representing the shedding effect of the described motion-movement on the water (H20) saturation at the cathode-electrode surface 304. Note, some depiction representations of this and other Figs. may be applied to other embodiments described as well.

FIG. 13 depicts an embodiment as represented in FIGS. 1 and 2 regarding shape of AEC assembly (i.e., preferred embodiment shape); and in FIG. 12 wherein the oxidation and reduction chambers take part in described motion-movement; except that the motion-movement of AEC assembly unit is an inertial, secondary, motion-movement occurring as a response within said motion-moving chambers. This secondary reaction, of the said AEC assembly unit, is relative and opposite to the first described motion-movement of the said chambers allowing for the enhanced reactant exposure to AEC assembly electrodes, according to the invention, over that described in FIG. 12. The similar parts, or parts performing the same, relatable or identical functions are here identified with numbers which will differ from those described above by multiples of one hundred; therefore, the following descriptions of the differing embodiment will begin here with 400(s); however, a motion absorbing means with a function and description identical to that depicted in FIG. 12 is identified as 307, 307A and 307B in FIG. 13. Similar parts and or functions of the following embodiment if previously explained or if obvious will not be repeated.

FIG. 13 is a partial cross sectional side view of a single cell AEC assembly unit (403, 404 and 404) and motion-moving sub-housing comprising said chambers defined by walls 401B, 402B and platform 401C, wherein described motion-movement, marked (D) (more specifically (D-1) and (D-3) explained below) as represented by the double headed arrow depicted outside chamber, is transmitted 412 and applied externally to the combined oxidation chamber and reduction chamber walls 401B and 402B (of which, within said walls, the attached said AEC assembly unit is mounted and supported upon a motion absorbing mount 407, having a spring like reactive capability 412B and appropriately weighted 413) and resulting in a secondary independent motion-movement of said AEC assembly unit (403, 404 and 405) independent of said motion-moving sub-housing (401B, 402B and 401C); said secondary motion-movement is marked (D) (more specifically (D-2) and (D-4) explained below) as represented by the double headed arrow depicted inside chamber area.

The first motion (transmitted from source mechanism 412 and 409) is referred to as (D-1), as indicated by the number (1) at the head of arrow marked (D) depicted with said arrow outside chamber area; the resulted secondary motion, as a response to inertial force, is referred to as (D-2), as indicated by the number (2) at the head of arrow marked (D) depicted with said arrow inside chamber area; the third motion (again, transmitted from motion source mechanism 412 and 409) is referred to as (D-3) as indicated by the number (3) at the head of arrow marked (D) depicted with said arrow outside chamber area; and the resulted secondary motion as a response to inertial force is referred to as (D-4), as indicated by the number (4) at the head of arrow marked (D) depicted with said arrow inside chamber area; described movements are to repeat over and over resulting in the described motion-movement of the AEC assembly according to the invention.

The said AEC assembly unit (403, 404 and 405) is fixed at its perimeter edge 406 to a motion absorbing mount 407, comprising a spring like reactive quality (depicted as a spring 412B) with an appropriate tension allowing for the inertial response at each end 406 of the said AEC assembly unit (403, 404 and 405) that is in the direction of described motion-movement (D). Any spring like reactive quality or tension 412B within the motion absorbing mount 407 may be simply a quality of material make-up (pliability) of said motion absorbing mount 407, or reactive spring like hardware 412B disposed within motion absorbing mount 407; that will facilitate and quantify an appropriate and effective amplitude of motion of said AEC assembly unit (403, 404 and 405).

The secondary moving portion 407B of the motion absorbing mount 407 may comprise added weight 413 (in addition to any weight that may be incorporated within the end portion 406) to provide any appropriate additional inertia transmission effect adding to the momentum (desired replication) of the secondary movement (D-2 and D-4). A motion-source mechanism comprising a transducer 409 fixed to stationary housing 401, and transmission means 412, is applied to the external side of the motion-moving sub-housing, comprising walls (and joining platform 401C) 401B and 402B containing said chambers to effect the said first and third motion-movements (D-1 and D-3).

It is conceivable that any of the described motion-movement(s) applied to the above disclosed embodiments may be alternated or combined with one or more said motion-movements; including any resulting gyration like motion-movements (not shown).

The differing embodiments described have been presented for purposes of illustration and description. While the invention has been presented with reference to details of the various embodiments, these details are not intended to be exhaustive or to limit the scope of the invention to the precise forms disclosed; rather the scope of the invention is to be defined by the claims to follow.

What is claimed is:

1. In a fuel cell system, comprising at least a single cell, wherein a mechanism engages and or transmits and thereby effects AEC assembly unit(s) (i.e., anode-electrode, electrolyte and cathode-electrode, including any interconnect and or casing materials(s) thereof), for the purpose of providing and or enabling a reciprocating and or oscillating and or vibrational motion-movement of said AEC assembly.

2. In a fuel cell system according to claim 1 wherein said reciprocating motion-movement of said AEC assembly unit, including any multiple of units thereof, is defined as any repeating back and forth, or up and down motion-movement, occurring between at least two points along any definable plane or straight line.

3. In a fuel cell system according to claim 1 wherein said oscillating motion-movement of said AEC assembly unit, including any multiple of units thereof, is defined as any repeating to and fro motion-movement, occurring between at least two points along any definable radial arc.

4. In a fuel cell system according to claim 1 wherein said vibrational motion-movement of said AEC assembly unit, including any multiple of units thereof, is defined as any repeating motion-movement, having a higher frequency of said repeating motion, with a smaller amplitude of range in movement between at least two points of definable movement.

5. In a fuel cell system according to claim 4 wherein said vibrational motion-movement is a reciprocating like or similar micro vibrational motion-movement of which is defined as any rapidly repeating back and forth and or up and down motion-movement, occurring between at least two points along any definable plane or straight line.

6. In a fuel cell system according to claim 4 wherein said vibration motion-movement is an oscillating like or similar micro vibrational motion-movement of which is defined as any rapidly repeating to and fro motion-movement, occurring between at least two points along any definable radial arc.

7. In a fuel cell system according to claim 4 wherein said vibration motion-movement comprises a combination of two or more said motion-movements; and or including any resulting gyration like or similar micro vibrational motion-movement thereof.

8. In a fuel cell system according to claim 1 wherein said mechanism comprises an electric motor.

9. In a fuel cell system according to claim 8 wherein the electric motor acts as a transducer devise to convert electrical energy into the source of any of described motion-movement(s).

10. In a fuel cell system according to claim 8 wherein said mechanism comprises a transmission means to transmit source of described motion-movement to effect described motion-movement to one or any number of said AEC assembly units.

11. In a fuel cell system according to claim 10 wherein said transmission means comprises a mechanical force or movement originating from one part of said mechanism, through and or to another part.

12. In a fuel cell system according to claim 10 wherein said transmission means comprises an electrical power communication originating from one part of said mechanism, through and or to another part.

13. In a fuel cell system according to claim 10 wherein said transmission means comprises an inertial force originating from one part of said mechanism, through and or to another part.

14. In a fuel cell system according to claim 13 wherein said inertial force results in a secondary described motion-movement;
(a) wherein AEC assembly may be appropriately weighted to better respond to said inertial force transmission.

15. In a fuel cell system wherein described motion-movement is separated and divided from other structure support and or housing or sub-housing by a motion absorbing mount of which comprises a give and take motion absorbing quality, function and capability; said motion absorbing mount being defined as a (first) part having a give and take motion absorbing quality, function or capability, on which a (second) part attached thereto may have said motion-movement(s) relative to an attached generally stationary (third) part.

16. In a fuel cell system according to claim 15 wherein motion absorbing mount comprises a moving portion and a stationary portion.

17. In a fuel cell system according to claim 15 wherein the structure and or form of a motion absorbing mount(s) resembles a ring or gasket shape, having a perimeter, diameter or radius to be attached, fixed, between the like perimeter, diameter or radius of said second and third parts;
(a) wherein said first part (motion absorbing mount(s)) serves as reactant chamber seal(s) between said second and third parts, and or reactant chambers.

18. In a fuel cell system according to claim 15 wherein an AEC assembly unit is structurally mounted to and or supported by motion absorbing mount.

19. In a fuel cell system according to claim 14 wherein motion absorbing mount comprises a spring like reactive quality to facilitate and quantify an appropriate response to an inertial force transmission.

20. In a fuel cell system according to claim 1 wherein the thickness of a wall comprising an AEC assembly unit (i.e., anode-electrode, electrolyte and cathode-electrode, including any interconnect and or casing material(s) thereof), having a described motion-movement (i.e., defined: reciprocating and or oscillating and or vibrational motion-movement(s)), divides and separates two spaces that allow for said described motion-movement comprised of and defined as: an anode-oxidation area at the said anode-electrode side of said AEC assembly unit, and a cathode-reduction area at the said cathode-electrode side of said AEC assembly unit;
(a) the anode-electrode side of said AEC assembly unit extending adjacent over the surface area of a stationary cooling delivery means and anode-fuel reactant exposure;
(b) the cathode-electrode side of said AEC assembly unit extending adjacent over the surface area of a stationary cathode chamber wall providing Groove channel means for cathode reactant delivery and for exhaust of same including by-product water.

21. In a fuel cell system according to claim 20 wherein said stationary cooling delivery means comprises pressure sealed channelling of coolant-medium within a wall or structural body of said stationary cooling delivery means.

22. In a fuel cell system according to claim 21 wherein said pressure sealed channelling of coolant-medium within said stationary cooling delivery means may be formed as ridges or attached tubing disposed at surface of said wall or structural body defined as said cooling delivery means;
(a) wherein the space between two said cooling ridges may approximate the amplitude of alternating described motion-movement(s) of said AEC assembly occurring between at least two points.

23. In a fuel cell system according to claim 1 wherein the described said motion-moving AEC assembly unit(s) are constructed in a cylindrical or tubular shape.

24. In a fuel cell system according to claim 1 wherein the described said motion-moving AEC assembly unit(s) are constructed in a plane shape (i.e., flat, planar shape).

25. In a fuel cell system according to claim 1 wherein the described said motion-moving AEC assembly unit(s) are constructed in a circular disk or plate shape.

26. In a fuel cell system according to claim 20 wherein cathode reactant and water exhaust channelling is formed as a gutter at draining edge of any flat, planar shape; or said circular disk or plate shaped cathode-electrode.

27. In a fuel cell system according to claim 16 wherein the means of electrical communication between a motion-moving circuit and a stationary circuit is comprised of a flexible or extendable electrical connection (or slacked insulated electrical wire connection) disposed within a portion of said motion absorbing mount.

28. In a fuel cell system according to claim 15 wherein described said motion-movement includes part or portions of a cathode chamber wall, or (and or) anode chamber wall, moving with an AEC assembly unit (i.e., anode-electrode, electrolyte and cathode-electrode, including any interconnect and or casing material(s) thereof).
